(19) United States
(12) Patent Application Publication
(10) Pub. No.: US 2017/0113831 A1
(43) Pub. Date: Apr. 27, 2017

(54) METHOD FOR PRODUCING A TWIN-WALL CUP FROM PAPER OR PAPER-LIKE MATERIAL, APPARATUS FOR CARRYING OUT THE METHOD AND TWIN-WALL CUP

(71) Applicants: Holger AUBELE, Boehmenkirch (DE); Uwe MESSERSCHMID, Albershausen (DE)

(72) Inventors: Holger AUBELE, Boehmenkirch (DE); Uwe MESSERSCHMID, Albershausen (DE)

(21) Appl. No.: 15/291,403

(22) Filed: Oct. 12, 2016

(30) Foreign Application Priority Data
Oct. 23, 2015 (DE) 10 2015 220 747.1

(51) Int. Cl. B65D 3/22; B31B 7/28; B65D 3/04

(52) U.S. Cl. CPC B65D 3/22; B65D 3/04; B31B 7/28; B31B 2217/003

(57) ABSTRACT

Method and apparatus for producing a twin-wall cup from paper or paper-like material including placing an inner cup with a sleeve and a base onto a mandrel, laying a flat segment onto an outer side of the inner cup, opposite to the mandrel, shaping the flat segment to form an outer jacket, which surrounds the inner cup, and fixing the outer jacket on the inner cup by means of a material engagement connection of outer jacket and inner cup, in particular by means of adhesive bonding, wherein at least one spacer is attached to an inner side of the flat segment and/or to an outer side of the sleeve of the inner cup before the flat segment is laid on the inner cup.

### CROSS-REFERENCE TO RELATED APPLICATIONS

This claims priority from German Patent Application No. 10 2015 220 747.1, filed Oct. 23, 2015, the disclosure of which is hereby incorporated by reference in its entirety into this application.

### FIELD, BACKGROUND AND SUMMARY OF THE INVENTION

With the invention, a method for producing a twin-wall cup is to be improved.

According to the invention, a method for producing a twin-wall cup from paper or paper-like material having the following steps is proposed for this purpose:
placing an inner cup with an in particular conical sleeve and a base onto a mandrel,
laying a flat segment onto an outer side of the inner cup, opposite to the mandrel,
shaping the flat segment to form an in particular conical outer jacket, which surrounds the inner cup,
fixing the outer jacket on the inner cup by means of a material engagement connection of outer jacket and inner cup, in particular by means of adhesive bonding, and
attaching at least one spacer to an inner side of the flat segment and/or on an outer side of the sleeve of the inner cup before laying the flat segment on the inner cup.

When winding an outer jacket onto an inner cup, the flat segment which is intended to form the outer jacket should be fixed to the inner cup before the actual winding operation, and therefore fixed until the conclusion of the winding operation. This is usually carried out by means of a clamping lever which presses the segment onto the inner cup. The opposing force is absorbed by a mandrel onto which the inner cup is pushed. The force needed for the secure fixing of the segment is necessarily so high that the previously applied adhesive between inner cup and segment is forced out of the pressing area. As a consequence, the air gap needed for the insulation of the cup between the inner cup and outer jacket is reduced to a non-tolerable extent in the area of the clamping lever. The finished cup is then restricted in terms of its function, possibly even unusable. In the method according to the invention, before the flat segment is laid on the inner cup, at least one spacer is attached to an inner side of the flat segment and/or to an outer side of the sleeve of the inner cup. The spacer is formed in such a way that it can no longer be deformed plastically or deformed only to a small extent. The spacer therefore serves to maintain the dimensions of the insulation gap even under the action of force from the clamping lever on the segment. As a result of the provision of the spacer, the segment can then be wound to form the outer jacket and it is possible to ensure that, on the finished cup, a substantially constant spacing between outer jacket and the sleeve of the inner cup is achieved. The twin-wall cup that is produced has very good insulating properties as a result.

Paper, board or paperboard, for example, is viewed as a paper material or paper-like material. For example, paper, board or paperboard can be present in flat segments, and these flat segments can then firstly be wound to form a sleeve having a circumferential wall and also deformed to form a base element that is pot-like, for example. The sleeve and the base are then connected to form an inner cup. The outer jacket is also produced from a flat segment. Expediently, the paper material is coated in a liquid-tight manner. In any case, the inner side of the inner cup should be coated in a liquid-tight manner. On the outer side of the inner cup and on the outer jacket, it is possible to dispense with a liquid-tight coating, also to make printing of the outer jacket easier. However, plastic material present in flat form, for example, is also viewed as a paper-like material if this is processed in the same way or at least in a similar way to form a cup or a lid. Flat plastic materials are also plastic laminates, for example. To produce an inner cup, outer jacket or lid, the flat plastic material which is present in segment form is likewise wound around a central mandrel and connected in the area of the overlap in order to form an in particular conical sleeve. A pot-like base or pot-like lid element can also be shaped from the flat plastic material by a circular blank being folded upward approximately vertically with respect to its bottom surface in its edge region. The problems which occur in the case of plastic material to be processed in a manner similar to paper are, however, substantially the same which occur when processing paper material. Specifically, plastic material to be processed in a paper-like manner can also not be deformed highly, for example bent, without losing its insulating properties and leak-proof properties. The present invention can be used for plastic materials to be processed in a paper-like manner but is not specifically designed for plastic materials to be processed in a paper-like manner but of course can also be used for paper material with considerable advantages.

In a development of the invention, the spacer is attached at least in the middle between the two side edges of the flat segment.

In this way, the spacer can provide an abutment when fixing the flat segment to the inner cup, and the segment can be wound to form the outer jacket with less expenditure of pressure.

In a development of the invention, the spacer on the finished cup runs in the direction from the base of the cup towards an opening of the cup.

In this way, the spacer can in particular be attached without difficulty to the segment without preventing bending of the segment during the winding of the outer jacket. Specifically, in the case of spacers running from the bottom to the opening of the cup, that is to say vertically, the spacers can also be arranged distributed over the segment and nevertheless do not hamper the bending of the segment during the winding of the outer jacket.

In a development of the invention, the attachment of the spacer comprises the application and solidification of at least one adhesive track, in particular hot-melt adhesive, wherein the spacer is formed by the solidified adhesive track.

As a result, a spacer can be attached in a surprisingly simple way. In order to bond the outer jacket to the inner cup, nozzles for the application of adhesive are needed in any case. Before the flat segment is laid on the outer side of the inner cup, according to the invention one or more adhesive tracks are applied to the outer side of the inner cup, for example by means of a nozzle, alternatively or additionally at least one adhesive track is applied to the inner side of the flat segment. Following the solidification of this adhesive track, the latter then serves as a spacer and the flat segment can be laid on the inner cup and fixed by means of a clamping lever. The outer jacket can then be wound from the flat segment.

In a development of the invention, the attachment of the spacer comprises the application and solidification of at least one track of paper pulp, wherein the spacer is formed by the solidified track of paper pulp.

Paper stock is designated paper pulp. By means of a track of paper pulp, which solidifies following application, a spacer can be implemented comparatively economically. A great advantage here is that the track of paper pulp can be applied in the continuous method, for example by means of a nozzle.

In a development of the invention, the attachment of the spacer comprises the application and solidification of at least one foam track, wherein the spacer is formed by the solidified foam track.

A spacer can also be implemented in a simple and economical way in the continuous method by means of a foam track. Here, it is possible to use a foam which hardens automatically following application.

In a development of the invention, the spacer has a height of at least 0.2 mm and at most 5 mm, preferably between 1 mm and 3 mm.

In this way, practical spacings between outer jacket and inner cup can be implemented. Even with a spacing of 0.2 mm, a good insulating effect is achieved, a very good insulating effect at 1 mm. Up to a spacing of 5 mm, the twin-wall cup produced is sufficiently stable. Of course, this also depends on the thickness of the material of the outer jacket and on the number of bonding points between outer jacket and inner cup. In general, however, it is true that the greater the adhesive area between outer jacket and inner cup, the worse the insulating effect of the cup produced becomes.

In a development of the invention, the spacer is applied to an inner side of the flat segment and, before the flat segment is laid on the inner cup, an outer side of the inner cup is provided with at least one adhesive track for fixing the outer jacket on the inner cup.

In this way, the segment is provided with one or more spacers and the outer side of the inner cup with at least one adhesive track. As a result, both the spacer and the adhesive track can be applied in a manner unaffected by each other. As the flat segment is laid on the inner cup, although the adhesive track is compressed where it is touched by the spacer, because of the spacer or multiple spacers, a spacing is nevertheless then maintained between the outer jacket and the inner cup during the winding of the outer jacket.

In a development of the invention, multiple strip-like spacers are applied distributed over the inner surface of the flat segment and/or over the outer surface of the inner cup.

In this way, a particularly uniform spacing over the entire circumference of the sleeve of the inner cup can be ensured.

In a development of the invention, multiple strip-like spacers running rectilinearly parallel to one another or, as viewed in the longitudinal direction of the strip-like spacers, with increasing or decreasing spacing from one another are arranged on the inner side of the flat segment.

The application of multiple strip-like spacers running rectilinearly to the inner side of the flat segment can be carried out in a particularly simple way in that, specifically during a linear transport movement of the flat segment, the spacers are applied by means of nozzles. On the finished cup, these strip-like spacers then run exactly in the vertical direction only in a cylindrical cup; in the case of a conical cup, the spacers then run obliquely with respect to the vertical direction. In order to arrange for the spacers on the finished cup to run exactly parallel to the vertical direction even in the case of a conical cup, these spacers can be arranged with increasing or decreasing spacing from one another on the inner side of the flat segment.

In an apparatus for carrying out the method according to the invention, at least one device, in particular a nozzle, for attaching the at least one spacer is provided.

By means of a nozzle, a spacer can be applied in a particularly simple way, for example by applying an adhesive track, a track of paper pulp or a foam track.

In a development of the invention, transport means are provided for moving the flat segment along a path that is rectilinear or circular in some sections, wherein the at least one device for attaching the spacer is arranged on a rectilinear or circular section of the path.

In this way, during the rectilinear or circular transport of the flat segment, a spacer or multiple spacers can be applied in a very simple way.

With the invention, an improved twin-wall cup of paper or paper-like material having an inner cup is provided, which cup has a sleeve and a base and is provided with an outer jacket which surrounds the inner cup, wherein, between the inner side of the outer jacket and the outer side of the sleeve of the inner cup, at least one strip-like spacer in the form of a solidified adhesive track, a track of solidified paper pulp and/or a solidified foam track with a height between 0.2 mm and 5 mm, in particular between 1 mm and 3 mm, is provided.

By providing one or more such spacers, it is firstly ensured that, when winding the outer jacket around the inner cup, a constant spacing between outer jacket and inner cup is achieved. Furthermore, in the event of providing multiple spacers, it is also possible to achieve the situation where a user, when gripping the cup, does not inadvertently reduce the spacing between outer jacket and inner cup. As a result, the insulating behaviour of the cup in use can be improved; the outer jacket can possibly also be made from thinner or less stable material.

### BRIEF DESCRIPTION OF THE DRAWINGS

Further features and advantages of the invention emerge from the claims and the following description of preferred embodiments of the invention in conjunction with the drawings. Individual features of the different embodiments illustrated and described can be combined with one another in any desired way without exceeding the scope of the invention. In the drawings:

FIG. 1 shows a schematic illustration of a method step of the method according to the invention during production of a twin-wall cup,

FIG. 2 shows a plan view of a flat segment which, in FIG. 1, is wound to form an outer jacket,

FIG. 3 shows a schematic illustration of a method step of the method according to the invention according to a further embodiment,

FIG. 4 shows a plan view of the flat segment which, in FIG. 3, is used to produce an outer jacket,

FIG. 5 shows a sectional view of a twin-wall cup according to the invention which has the flat segment illustrated in FIG. 4 as outer jacket,

FIG. 6 shows a flat segment for producing an outer jacket in accordance with the method according to the invention, according to a further embodiment,

FIG. 7 shows a view of a cup according to the invention according to a further embodiment, wherein the sleeve of an inner cup and the outer jacket are illustrated dashed and transparently,

FIG. 8 shows a side view of the cup from FIG. 7, wherein the complete inner cup and the outer jacket are illustrated transparently,

FIG. 9 shows a plan view of a flat segment of a further embodiment of the invention,

FIG. 10 shows a plan view of a flat segment according to a further embodiment of the invention, and

FIG. 11 shows a plan view of a flat segment according to a further embodiment of the invention.

### DETAILED DESCRIPTION

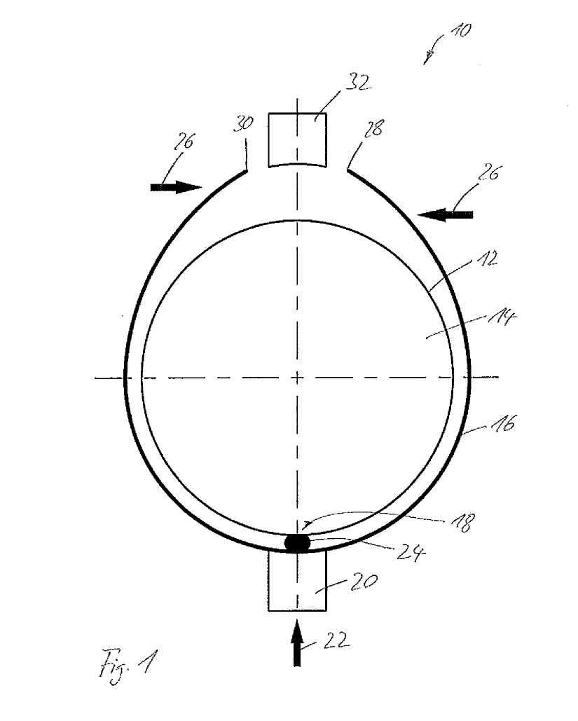

FIG. 1 shows, schematically, a section of an apparatus for carrying out the method according to the invention. Illustrated schematically is an inner cup 12, which has been pushed onto a mandrel 14. The inner cup 12 has a sleeve and a base connected in a substantially liquid-tight manner to the sleeve. The inner cup 12 can already be provided at its upper edge, opposite the base, with what is known as a mouth roll. The mouth roll is formed by rolling in the upper end of the sleeve and gives a user of the cup an acceptable feeling when said user places the mouth roll on the lips.

During one step of the method according to the invention, an originally flat segment 16 is wound on the inner cup 12 to form an outer jacket, which can be cylindrical or frustoconical. To this end, the flat segment 16 is laid on the inner cup at a point 18 and the flat segment 16 is then pressed against the inner cup 12 by means of a clamping lever 20. The clamping lever 20 exerts a force 22, wherein an opposing force is applied by the mandrel 14 onto which the inner cup 12 has been pushed.

At the point at which it is laid on the inner cup 12, the flat segment 16 bears a spacer 24. The spacer 24 is formed in the shape of a line or strip and, in the embodiment illustrated, consists of a solidified adhesive track. The adhesive track is applied to the segment 16 in the flat state of the latter and consists of a hot-melt adhesive. The adhesive track of hot-melt adhesive that is applied solidifies comparatively quickly as it cools down and, in the solidified state of FIG. 1, is still only slightly plastically deformable. The force 22 applied to the outer side of the segment 16 by the clamping lever 20 therefore leads only to slight plastic deformation of the spacer 24. However, it can be gathered from FIG. 1 that, on the right and left of the spacer 24, a spacing between the segment 16 and the inner cup 12 is maintained. This spacing lies between 0.2 mm and 5 mm, in particular between 1 mm and 3 mm, according to an advantageous refinement of the invention, and this spacing is achieved over the entire circumference of the inner cup 12, between the inner cup 12 and the finished outer jacket.

After the flat segment 16 has been laid and pressed on by means of the clamping lever 20, the flat segment 16 is wound to form an outer jacket. This is indicated schematically in FIG. 1 by two arrows 26. The arrows 26 are intended generally to illustrate an action of force on the segment 16, so that the latter is wound around the inner cup 12, for example by levers, fingers or half-shells 27 matched to the cup contour. A force is applied somewhat higher on the left than on the right, in order to be able to produce an overlap at the segment edges.

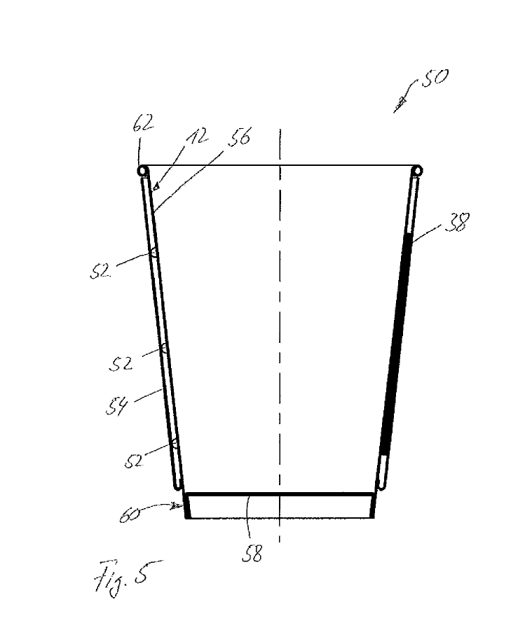

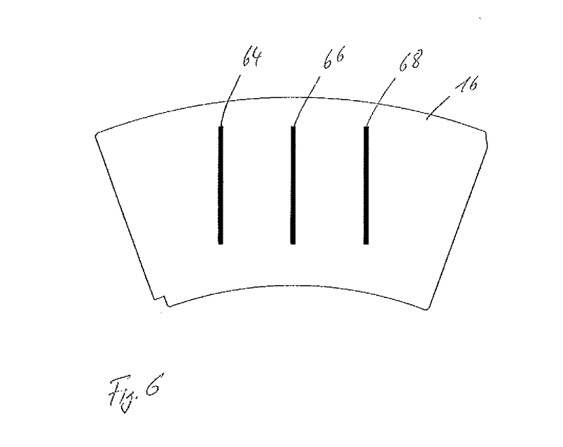

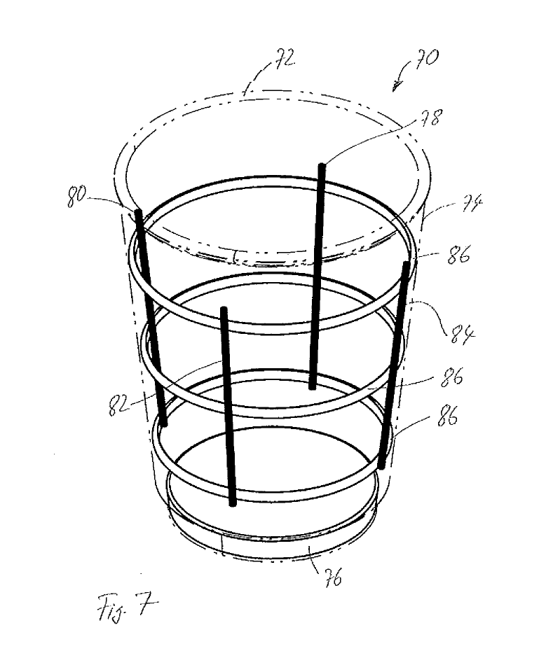

The segment 16 is thus laid around the inner cup 12 until the areas adjoining a first side edge 28 and a second side edge 30 overlap. The overlap that is produced is then pressed against the inner cup 12 by means of a further clamping lever 32. The segment 16 then forms an outer jacket, which is fixed in its final form by adhesive, which is not illustrated in FIG. 1. Here, the adhesive can be applied to the areas of the segment 16 which adjoin the side edges 28, 30. In the embodiment illustrated, adhesive tracks, which are not illustrated in FIG. 1, running around the inner cup 12 are applied and then connect the segment 16 to the inner cup 12. Such adhesive tracks are illustrated schematically, for example in FIG. 5, FIG. 7 and FIG. 8.

With the method according to the invention, it is possible to avoid the segment 16 coming into contact with the inner cup 12 as a result of the clamping lever 20. Instead, by means of the spacer 24, even in the area between the clamping lever 20 and the inner cup 12, a spacing between inner cup 12 and the segment 16 or the finished outer jacket is maintained.

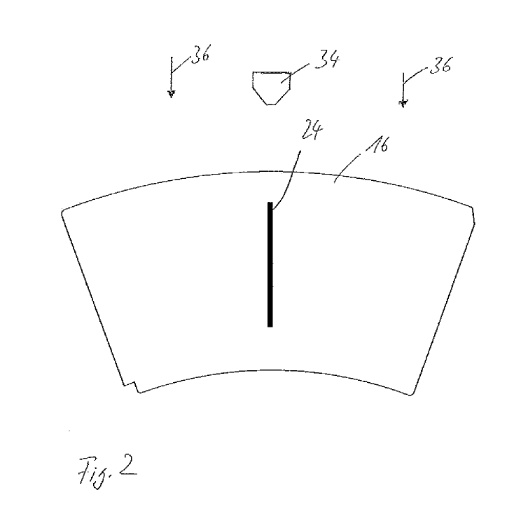

The illustration of FIG. 2 shows the flat segment 16 before being laid on the inner cup 12. It is easy to see the spacer 24 in the form of a solidified adhesive track of hot-melt adhesive. The adhesive track can be applied, for example, by means of a nozzle 34, illustrated schematically in FIG. 2, while the flat segment is moved under the nozzle 34 in the direction of the arrows 36 by transport means, not illustrated. The transport means can be formed, for example, as a transport belt and, during a linear movement of the flat segment 16, the spacer 24 in the form of an adhesive strip of hot-melt adhesive is applied by means of the nozzle 34. As soon as this hot-melt adhesive has cooled, a solidified adhesive track is available, which then forms the spacer 24.

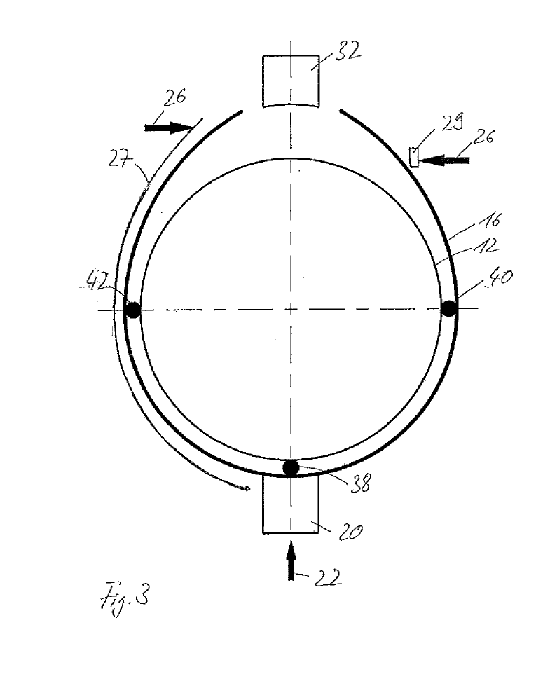

The illustration of FIG. 3 shows a further embodiment of the invention. As distinct from the method explained by using FIG. 1, the flat segment 16 is provided with a total of three strip-like spacers 38, 40, 42. The spacer 38 is arranged at the same position as the spacer 24 in FIGS. 1 and 2. The likewise strip-like spacers 40, 42 are arranged to be spaced apart by 90° relative to the spacer 38 and ensure that, as the flat segment 16 is wound to form an outer jacket which surrounds the inner cup 12, a constant spacing between inner cup 12 and the segment 16 and the outer jacket is also ensured at a distance from the spacer 38. By way of example, illustrated on the left is a half-shell 27, with which the left-hand section of the segment 16 is moved inward. Illustrated on the right by way of example is a finger 29, in order to move the right-hand section of the segment 16 inward and to produce the overlap. Of course, half-shells or fingers can be used on both sides.

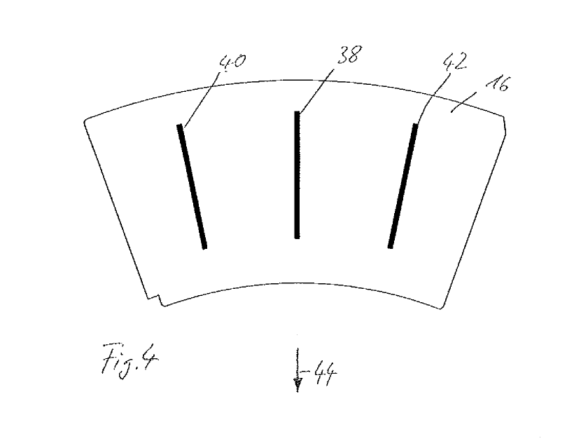

The illustration of FIG. 4 shows the flat segment 16 from FIG. 3 with the strip-like spacers 38, 40 and 42. It can be seen from FIG. 4 that, in the longitudinal direction of the strip-like spacers 40, 38, 42, a distance between the spacers 38, 40, 42 decreases or increases, depending on the direction along the spacers 38, 40, 42 in which it is viewed.

The central spacer 38 can, as illustrated in FIG. 2, be applied by using a stationary nozzle 34, while the flat segment 16 is moved in a transport direction 44. The spacers 40, 42 can be applied with nozzles which change their position during the transport past of the segment 16. Alternatively, the spacers 38, 40, 42 can be applied one after another and an alignment of the segment 16 relative to the transport direction 44 is changed between the application of the individual spacers 38, 40, 42.

The illustration of FIG. 5 shows a sectional view of a twin-wall cup 50 according to the invention which has been produced in accordance with FIG. 3. In the sectional view of FIG. 5 it is possible to see only spacer 38. Also in FIG. 5, it is possible to see a total of three adhesive strips 52 running around the inner cup 12, which connect the frustoconical outer jacket 54 to a likewise frustoconical sleeve 56 of the inner cup 12.

The outer jacket 54 ends shortly above a base 58 of the inner cup 12 which, in the area of a bottom rib 60, is connected to the sleeve 56 in a substantially liquid-tight manner. At its upper edge, opposite the base 58, the sleeve 56 is provided with a mouth roll 62. The outer jacket 54 ends shortly underneath the mouth roll 62.

It can be seen that, on the finished twin-wall cup 50, not only the spacer 38 but also the spacers 40, 42 which cannot be seen ensure a spacing between outer jacket 54 and the sleeve 56 of the inner cup 12 when the cup is used. In addition, the adhesive tracks 52 are solidified on the finished cup 50 and prevent a user bringing the outer jacket 54 against the outer jacket 54 into contact with the sleeve 56 of the inner cup 12 and, as a result, considerably impair the insulating effect of the cup 50. Instead, by means of the invention, very stable twin-wall cups can be produced, which are also suitable for high filling quantities of hot or cold beverages.

The illustration of FIG. 6 shows a flat segment 16 which has been provided with a total of three strip-like spacers 64, 66, 68. As distinct from the spacers 38, 40, 42 of the segment 16 of FIG. 4, the strip-like spacers 64, 66, 68 are arranged parallel to one another. The spacers 64, 66, 68 can thus be applied by means of stationary nozzles during rectilinear transport of the flat segment 16.

The illustration of FIG. 7 shows a twin-wall cup 70 according to the invention according to a further embodiment of the invention. In order to be able to illustrate the inner structure of the cup 70, a sleeve 72 of the inner cup and an outer jacket 74 are illustrated transparently and merely indicated by dashed lines. A base 76 of the inner cup 72, on the other hand, is illustrated by continuous lines.

Likewise illustrated by continuous lines are a total of four strip-like spacers 78, 80, 82, 84, which run parallel to a vertical direction of the cup 70 and are arranged spaced uniformly from one another between the outer jacket 74 and the inner cup 72. Likewise illustrated by continuous lines are three adhesive tracks 86 running around the inner cup 72, which are arranged spaced uniformly from one another.

During the production of the cup 70, firstly the inner cup 72 is pushed onto the mandrel 14, see FIG. 1. The outer side of the inner cup 72 is provided with the three circumferential adhesive tracks 86.

Then, see FIG. 1, a flat segment 16, which is provided with four strip-like spacers 78, 80, 82, 84 in the form of solidified adhesive tracks of hot-melt adhesive, is laid on the inner cup 72. The segment is pressed against the inner cup 72 by means of the clamping lever 20, see FIG. 1, and the segment is then shaped to form the outer jacket 74. The shape of the outer jacket is then maintained by the adhesive action of the adhesive tracks 86, which solidify and connect the outer jacket 74 to the inner cup 72. The twin-wall cup 70 is extremely stable as a result and exhibits excellent insulating properties. The cup 70 can also be produced in a simple and economical way.

The illustration of FIG. 8 shows a side view of the cup 70 from FIG. 7, wherein once more the inner cup 72 including its base 76 and the outer jacket 74 is illustrated transparently and with dashed lines.

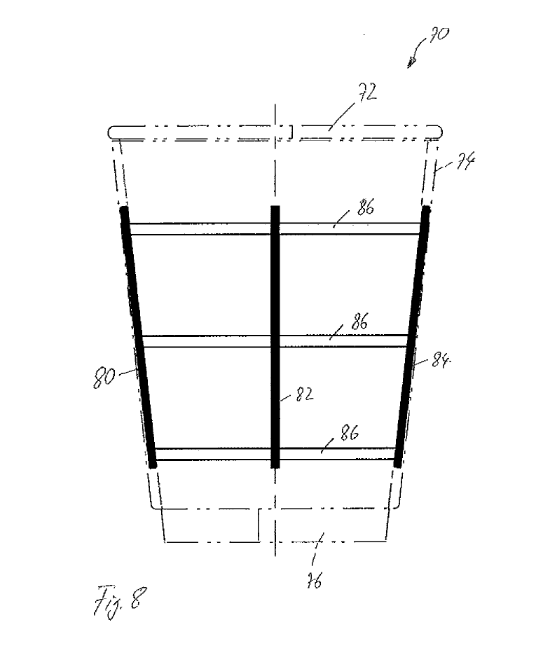

The illustration of FIG. 9 shows, in a plan view, a segment 90 which, according to the invention, can be wound to form an outer jacket. Arranged in the centre of the segment are multiple spacers 92 in the form of mutually parallel short strips spaced apart from one another. The spacers 92 have the shape of a circular section, which cannot be readily seen in the illustration of FIG. 9. The spacers 92 are applied, for example by means of a device, in particular a nozzle, while the segment 90 is moved along a circular path.

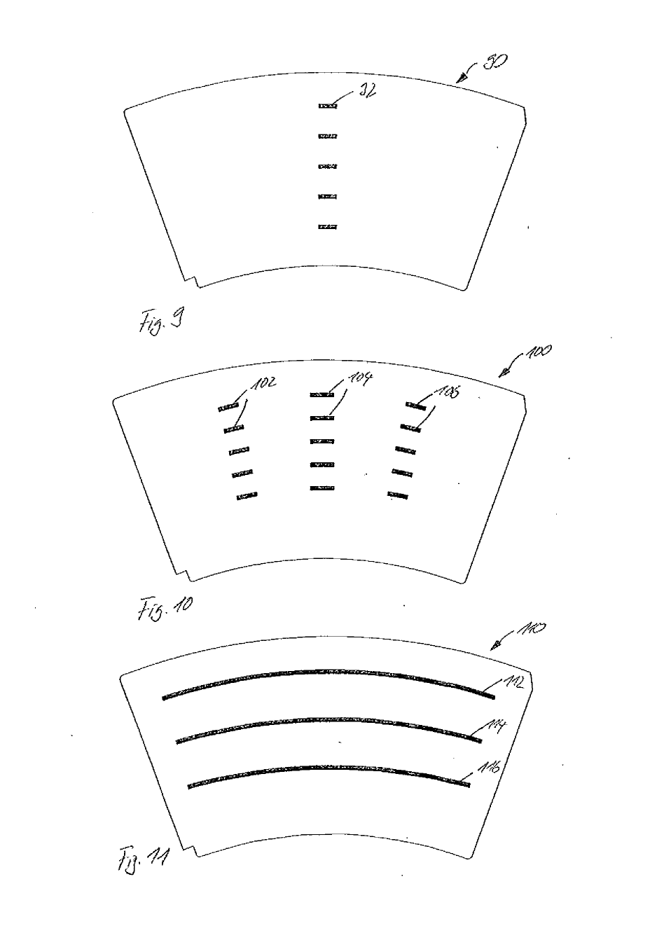

The illustration of FIG. 10 shows a segment 100 according to a further embodiment of the invention. Segment 100 can be wound to form a frustoconical outer jacket.

Spacers 102, 104 and 106 are arranged in the form of multiple short strips on an inner side of the segment 100. Overall, respectively five strip-like spacers 102, 104 and 106 are provided. The strip-like spacers 102, 104, 106 are applied by means of a device, in particular a nozzle, while the segment 100 is moved under the device on a path in the shape of a circular arc.

The illustration of FIG. 11 shows a segment 110 according to a further embodiment of the invention. The segment 110 can be wound to form an outer jacket. The segment 110 is provided with three spacers 112, 114 and 116 in the form of sections of a circular arc. The spacers 112, 114, 116 are arranged parallel to one another. The spacers 112, 114, 116 are applied by means of a device, in particular a nozzle, while the segment 110 is moved underneath the device along a path in the shape of a section of a circular arc.

1. Method for producing a twin-wall cup from paper or paper-like material, having the following steps:
placing an inner cup with a sleeve and a base onto a mandrel,
laying a flat segment onto an outer side of the inner cup, opposite to the mandrel,
shaping the flat segment to form an outer jacket, which surrounds the inner cup, and
fixing the outer jacket on the inner cup by means of a material engagement connection of outer jacket and inner cup, in particular by means of adhesive bonding,
attaching at least one spacer to an inner side of the flat segment and/or on an outer side of the sleeve of the inner cup before laying the flat segment on the inner cup.

2. Method according to claim 1, wherein the spacer is attached at least in the middle between the two side edges of the flat segment.

3. Method according to claim 1, wherein the spacer on the finished cup runs in the direction from the base of the cup towards an opening of the cup.

4. Method according to claim 1, wherein the attachment of the spacer comprises the application and solidification of at least one adhesive track, in particular hot-melt adhesive, wherein the spacer is formed by the solidified adhesive track.

5. Method according to claim 1, wherein the attachment of the spacer comprises the application and solidification of at least one track of paper pulp, wherein the spacer is formed by the solidified track of paper pulp.

6. Method according to claim 1, wherein the attachment of the spacer comprises the application and solidification of at least one foam track, wherein the spacer is formed by the solidified foam track.

7. Method according to claim 4, wherein the adhesive track the track of paper pulp and/or the foam track is applied continuously, interruptedly or in the form of spots.

8. Method according to claim 1, wherein the spacer has a height of at least 0.2 mm and at most 5 mm, preferably between 1 mm and 3 mm.

9. Method according to claim 1, wherein the spacer is applied to an inner side of the flat segment and in that before the flat segment is laid on the inner cup, an outer side of the inner cup is provided with at least one adhesive track for fixing the outer jacket on the inner cup.

10. Method according to claim 1, wherein multiple strip-like spacers are applied distributed over the inner surface of the flat segment and/or over the outer surface of the inner cup.

11. Method according to claim 10, wherein multiple strip-like spacers running rectilinearly parallel to one another or, as viewed in the longitudinal direction of the strip-like spacers, with increasing or decreasing spacing from one another are arranged on the inner side of the flat segment.

12. Apparatus for carrying out the method according to claim 1, including at least one device, in particular a nozzle, for attaching the at least one spacer.

13. Apparatus according to claim 12, including transport means for moving the flat segment along a path that is rectilinear, at least in some sections, wherein the at least one device, in particular a nozzle, for attaching the spacer is arranged on a rectilinear section of the path.

14. Apparatus according to claim 13, including transport means for moving the flat segment along a path that is circular, at least in some sections, wherein the at least one device for attaching the spacer is arranged on a circular section of the path.

15. Twin-wall cup of paper or paper-like material comprising an inner cup which has a sleeve and a base, and having an outer jacket which surrounds the inner cup, wherein, between the inner side of the outer jacket and the outer side of the sleeve of the inner cup, at least one strip-like spacer in the form of a solidified adhesive track, a track of solidified paper pulp and/or a solidified foam track with a height between 1 mm and 5 mm is provided.

16. Twin-wall cup according to claim 15, wherein the spacer consists of a material that can be foamed, a board or a solid plastic material.
